(19) United States
(12) Patent Application Publication
(10) Pub. No.: US 2023/0176834 A1
(43) Pub. Date: Jun. 8, 2023

(54) GRAPHICAL PROGRAMMING ENVIRONMENT

(71) Applicant: Cognex Corporation, Natick, MA (US)

(72) Inventors: Lou Palmieri, Framingham, MA (US); Robert Vanca, Budapest (HU); James Dunning, Natick, MA (US); Adam Horvath, Budapest (HU)

(73) Assignee: Cognex Corporation, Natick, MA (US)

(21) Appl. No.: 18/076,183

(22) Filed: Dec. 6, 2022

Related U.S. Application Data
(60) Provisional application No. 63/286,702, filed on Dec. 7, 2021.

(51) Int. Cl. G06F 8/34

(52) U.S. Cl. CPC G06F 8/34

(57) ABSTRACT

The techniques described herein relate to methods, apparatus, and computer readable media for editing a graphical program using a graphical programming interface. Editing the graphical program may include displaying, via the graphical programming interface, a plurality of existing graphical components that provide functionality for at least one computer program thread; receiving data indicating a selection of a new graphical component for inserting into the plurality of existing graphical components; determining, based on an associated graphical component of the plurality of existing graphical components, a set of one or more placement locations for inserting the new graphical component; and displaying, on the graphical programming interface, the set of one or more placement locations.

### RELATED APPLICATIONS

This Application claims priority under 35 U.S.C. § 119(e) to U.S. Provisional Application Serial No. 63/286,702, titled “GRAPHICAL PROGRAMMING ENVIRONMENT,” filed on Dec. 7, 2021, which is herein incorporated by reference in its entirety.

### TECHNICAL FIELD

The techniques described herein relate generally to methods and apparatus for programming using a graphical programming interface, including techniques for programming a machine vision system.

### BACKGROUND OF INVENTION

Graphical programming interfaces may allow users to create programs through the manipulation of graphical components associated with code. These programs can be developed for use with systems comprising components such as sensors, cameras, processors, and may frequently become complex interconnected systems composed of many components. Often, such systems are used and programmed by users having little to no programming expertise. However, graphical programming interfaces typically require users to place graphical components and manually determine data flow between the components. It may be difficult for such users to determine data flow and often leads to faulty programs due to user error. Therefore, it is desirable to provide a graphical programming interface for systems (e.g., machine vision systems) that can be used by non-expert users.

### SUMMARY OF INVENTION

In accordance with the disclosed subject matter, apparatus, systems, and methods are provided for improved techniques editing a graphical program using a graphical programming interface. According to some examples, the computerized method includes displaying, via the graphical programming interface, a plurality of existing graphical components that provide functionality for at least one computer program thread; receiving data indicating a selection of a new graphical component for inserting into the plurality of existing graphical components; determining, based on an associated graphical component of the plurality of existing graphical components, a set of one or more placement locations for inserting the new graphical component; and displaying, on the graphical programming interface, the set of one or more placement locations.

According to some examples, the computerized method includes receiving data indicating a selected placement location from the set of one or more placement locations; and adding the new graphical component into the plurality of existing graphical components based on the selected placement location.

According to some examples, the computerized method includes receiving data indicating a second graphical component of the plurality of existing graphical components near which the selected graphical component to the plurality of existing graphical components may be added; determining, based on the second graphical component, a second set of one or more placement locations for inserting the new graphical component into the plurality of existing graphical components near the second graphical component; and displaying, on the graphical programming interface, the second set of one or more placement locations.

According to some examples, the second graphical component is a graphical component of the plurality of existing graphical components determined to overlap the new graphical component in the graphical programming interface compared to other associated positions of the remaining existing graphical components of the plurality of existing graphical components.

According to some examples, the associated graphical component is a graphical component of the plurality of existing graphical components determined to be a last edited graphical component.

According to some examples, the new graphical component is associated with code and the code is configured with one or more parameters.

According to some examples, the computerized method includes receiving data indicating a selection of an event-driven graphical component.

According to some examples, the computerized method includes receiving data indicating placement of the event-driven graphical component; adding the event-driven graphical component and automatically adding a termination graphical component connected to the new graphical component; and adding, automatically, one or more parameters associated with the event-driven graphical component and the termination graphical component to a structure in memory.

According to some examples, the computerized method includes adding the new graphical component further comprises determining, automatically, one or more connections between the new graphical component and one or more graphical components of the plurality of existing graphical components; and displaying one or more connections between the new graphical component and the one or more graphical components.

According to some examples, the one or more connections indicate data flow, processing flow, or both, between the new graphical component and the one or more graphical components.

According to some examples, determining the one or more placement locations comprises determining, based on rules associated with the new graphical component and/or the associated graphical component, one or more locations in the plurality of existing graphical components in which the new graphical component can be added, and displaying the one or more placement locations comprises determining a layout for displaying the one or more placement locations and the plurality of existing graphical components.

According to some examples, the at least one graphical component of the plurality of existing graphical components comprises a link.

According to some examples, the method further includes redirecting to another interface in response to the selection of the link.

According to some examples, the method includes displaying on the graphical programming interface, in response to a selection of at least one graphical component of the plurality of existing graphical components, a dialog box, wherein the dialog box is automatically populated with one or more options for data that can be input to code associated with the at least one graphical component based on data from code associated with graphical components that will be executed prior to the code associated with the at least one graphical component.

According to some examples, the method includes receiving data indicating selection of a combining graphical component for combining two or more graphical components; displaying a prompt to select two or more graphical components of a plurality of existing graphical components; and combining two or more graphical components based on a selection of two or more graphical components.

According to some examples, the method includes launching the at least one computer program thread in response to input.

According to some examples, the method includes executing code associated with the new graphical component and/or code associated with one or more of the plurality of existing graphical components when a condition is met.

According to some examples, the method includes modifying a structure corresponding to the at least one computer program thread based on adding the new graphical component and/or the selected placement location of the new graphical component.

According to some examples, the method includes executing the at least one computer thread by executing pre-compiled code associated with the new graphical component and pre-compiled code of the at least one computer program thread associated with the plurality of existing graphical components.

According to some examples, the pre-compiled code associated with the new graphical component is configured with one or more parameters determined by the selected placement location of the new graphical component.

According to some examples, the method includes executing code of the at least one computer program thread associated with one or more graphical components of the plurality of existing graphical components in response to input; and pausing execution of the at least one computer program thread automatically upon completing execution of code associated with the one or more graphical components.

According to some examples, the graphical programming interface is a web interface.

According to some examples, indicating a graphical component on the graphical programming interface during execution of code associated with the graphical component of the plurality of existing graphical components.

According to some examples, the method includes executing code of the at least one computer program thread associated with one or more graphical components of the plurality of existing graphical components; and displaying data on the graphical programming interface, wherein the data is an output of the executed code.

According to some examples, a first graphical component of the plurality of existing graphical components is connected to a second graphical component of the plurality of existing graphical components, wherein a position of the first graphical component directly connected to the left of the second graphical component represents that code associated with the first graphical component will be executed before code associated with the second graphical component is executed, wherein a position of the second graphical component directly connected above the first graphical component represents that code associated with the second graphical component is executed in response to an error during execution of code associated with the first graphical component, and wherein a position of the second graphical component directly connected below the first graphical component represents that code associated with the second graphical component is a sub-step of code associated with the first graphical component.

Some embodiments relate to a system comprising a memory storing instructions, and a processor configured to execute the instructions to perform the method of any of the embodiments herein.

Some embodiments relate to a non-transitory computer-readable media comprising instructions that, when executed by one or more processors on a computing device, are operable to cause the one or more processors to execute the method of any of the embodiments herein.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 is a diagram showing an exemplary system for programming using a graphical programming interface, according to some embodiments.

FIG. 2 is a flow chart showing an exemplary computerized method for editing a graphical program using a graphical programming interface, according to some embodiments.

FIG. 3 is a launch screen of an application for an exemplary graphical programming interface, according to some embodiments.

FIG. 4 is a view of the exemplary graphical programming interface following initialization, according to some embodiments.

FIG. 5A is a view of the exemplary graphical programming interface when a user selects a graphical component for acquiring data, according to some embodiments.

FIG. 5B is an exemplary dialog box for selecting a device for acquiring data, according to some embodiments.

FIG. 6A is a view of the exemplary graphical programming interface when a user selects a graphical component for running a process, according to some embodiments.

FIG. 6B is an exemplary dialog box for editing a run process, according to some embodiments.

FIG. 7A is a view of the exemplary graphical programming interface when a user selects a graphical component for writing data, according to some embodiments.

FIG. 7B is an exemplary dialog box for editing an input/output (I/O) process, according to some embodiments.

FIG. 8 is a view of the exemplary graphical programming interface when a user selects a graphical component for an event-driven process, according to some embodiments.

FIG. 9 is a view of the exemplary graphical programming interface when a user selects a graphical component for combining two or more event-driven processes, according to some embodiments.

FIG. 10 is another view of the exemplary graphical programming interface, according to some embodiments.

### DETAILED DESCRIPTION OF INVENTION

The techniques described herein provide for techniques that can be used to program using a graphical programming interface, including techniques for developing programs for machine vision systems. The inventors have appreciated that conventional graphical programming techniques and systems may suffer from various inefficiencies, such as by requiring users to determine where to place graphical components and how to connect graphical components. Programming using such conventional graphical programming interfaces can be time consuming, and may also lead to frequent user error.

The inventors have developed technological improvements to address these and other inefficiencies. According to some embodiments, the techniques described herein can include providing placement location options for placing the graphical components (which are visual representations of associated code portions / functionality) within a graphical program. For example, such techniques can be used to provide placement location options when a user is adding a new graphical component to a graphical program. According to some embodiments, the techniques can include automatically determining connections between graphical components, where the connections are used to visually represent how to handle the input(s) and/or output(s) of a graphical component. As a result, users are not left to figure out on their own where a graphical component can (or cannot) be added within the graphical program. Additionally, or alternatively, the user is not left to manually connect newly added graphical components to other components in the current program. Accordingly, the system can automatically ensure components are added at valid locations. Additionally, or alternatively, the system can ensure that program flows are maintained by automatically adding the graphical component (and any other associated components) into the graphical program with the proper connection(s) to other components present in the program.

According to some embodiments, the inventors have developed clickable or selectable links that can be used to automatically guide a user through user interface(s) that are used to add and/or program graphical components. For example, by selecting a link associated with a graphical component, a user can be navigated to a new user interface associated with the link, allowed to perform any associated configuration and/or programming via the new interface, and then automatically returned back to the graphical program. As a result, a user can be provided with a much simpler and easier programming experience, compared to the user needing to navigate across a multitude of user interfaces on their own in order to set up and configure the program.

According to some embodiments, the techniques provide for prompting users with custom dialog boxes that allow the user to easily configure aspects of the graphical program. Such dialog boxes can include information and/or other aspects that are automatically populated or configured based on the graphical program. For example, the dialog box can include selectable and/or configurable information that is populated based on graphical component(s) in the graphical program that would be available to the graphical component. As a result, the pre-configured aspects of the user-interface can dynamically change for a graphical component to customize the user interface to the particular graphical component and/or the context of the graphical program. The underlying computer program can be designed with one or more execution threads. In some embodiments, the configurable aspects can be constrained such that they only reflect data available at that time in the thread and/or configuration options available at that time in the thread (e.g., rather than showing all possible data in the system, which may not apply to the graphical component). In some embodiments, a visual hint or queue can be added to a graphical component to provide an indication of configured aspect(s) of the graphical component.

In some embodiments, the techniques provide for helping a user to combine multiple aspects of the graphical program. The techniques can, for example, allow a user to indicate that the user would like to combine aspect(s) of the graphical program. The techniques can display to the user the components and/or aspects of the graphical program that can be combined by the operation (e.g., while temporarily hiding and/or graying out aspects that cannot be combined based on the configuration of the graphical program). As a result, the user need not drag-and-drop and/or perform other complex user interface options to combine aspects of the graphical program.

In some embodiments, the techniques provide for long-term processes, including processes that can execute across periods of time and/or have multiple outputs (e.g., user interface (UI) updates, data updates, etc.). In some embodiments, the techniques can include graphical indicator(s) showing, using visual indications in the graphical program, the execution steps of the graphical program. In some embodiments, the techniques can provide for a step-by-step execution and/or debugging process, that allows a user to execute one or a set of aspects of the graphical program, and then pause execution (e.g., to allow the user to check the program progress, outputs, etc.).

The techniques can be provided using various configurations, including through locally-executed applications and/or remotely-executing applications. For example, in some embodiments, the techniques can provide for a graphical programming environment that is accessible through a web interface. Accordingly, aspects of the graphical programming environment can be executed remote from the user device and provided to the user device in an easy-to-access manner through a web browser or other web interface. Such configurations can allow, for example, for existing programs on remote devices to be modified in real-time without needing to be present at the location of the remote devices. Such configurations can additionally or alternatively allow low-power and low-processing devices to obtain the benefits of the graphical programming environment (e.g., mobile users).

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

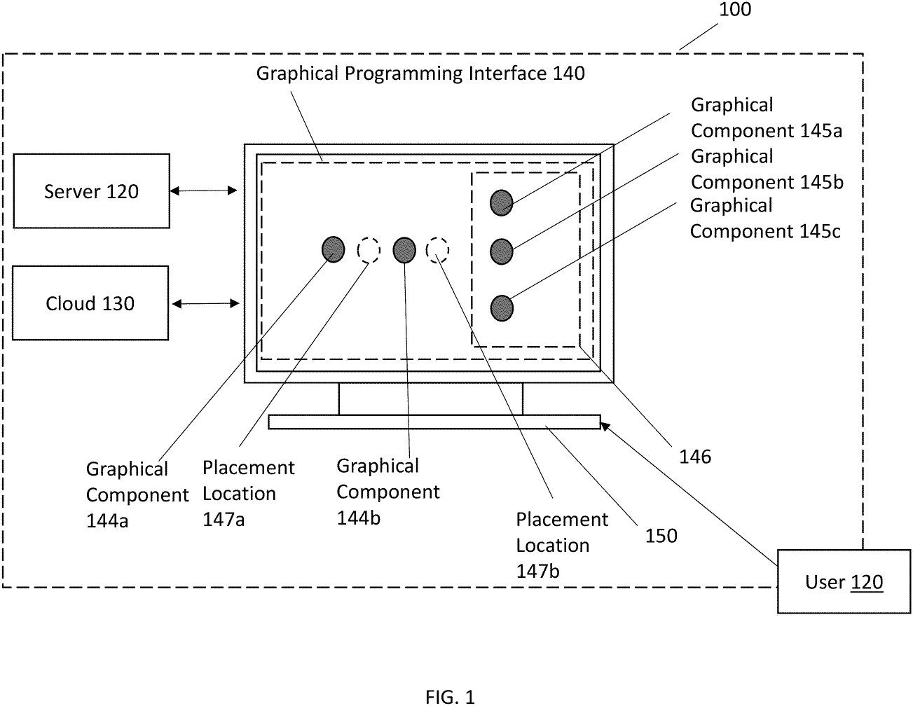

FIG. 1 is a diagram showing an exemplary system 100 for programming using a graphical programming interface, according to some embodiments. The exemplary system 100 includes a graphical programming interface 140, which may be provided on a display of a computer 150. The computer 150 can be any computing device, and can include one or more processors and optionally one or more input devices (e.g., a keyboard, a mouse, a track ball, a touchscreen, etc.). The computer 150 may also be in communication with a server 120 and/or cloud 130. A user 120 may interact with aspects of the graphical programming interface, for example, by using the one or more input devices of the computer 150.

As shown in the example of FIG. 1, the graphical programming interface 140 may display, to the user 120, one or more graphical components such as graphical components 144a-b and 145a-c. Each of the graphical components may be associated with functionality, such as that performed by computer program code. For example, each graphical component may be a user interface (UI) representation associated with piece(s) of software, such as pre-compiled code and/or other executable code (e.g., scripts). In some embodiments, for graphical components associated with pre-compiled code, the system can maintain a set of configurations that configure how each of the associated pre-compiled code portions work together according to the design of the graphical program.

In the example shown in FIG. 1, the graphical components 144a-b may be existing graphical components of a graphical program being designed in the interface 140, and provide (e.g., specify and/or configure) functionality for one or more computer program threads. The user may interact using the computer 150 and input device(s) of the computer 150 to select one or more new graphical components for inclusion into the graphical program, such as one of the graphical components 145a-c in area 146 (e.g., which may include template components that can be added to a graphical program). For example, one or more of the graphical components 145a-c can be inserted into the existing graphical components 144a-b to further specify the functionality of the graphical program. Based on an associated graphical component of the existing graphical components 144a-b, a set of one or more placement locations 147a-b for inserting the new graphical component into the thread may be determined by computer 150, server 120 and/or cloud 130 in communication with computer 150. The one or more placement locations 147a-b is displayed on the graphical programming interface 140 to help guide the user through the graphical program development. For example, the one or more placement locations 147a-b can indicate the possible locations the user can place a selected new graphical component so that it properly interacts with the existing graphical components 144a-b.

Examples of computer 150 can include, but are not limited to a single server computer, a series of server computers, a single personal computer, a series of personal computers, a minicomputer, a mainframe computer, a smartphone, a tablet and/or a computing cloud. The various components of computer 150 can execute one or more operating systems, examples of which can include but are not limited to: Microsoft Windows 11™; Microsoft Windows Server™; Novell Netware™; Yocto Linux™; Redhat Linux™, Unix, and/or a custom operating system, for example. The one or more processors of the computer 150 can be configured to process operations stored in memory connected to the one or more processors. The memory can include, but is not limited to, a hard disk drive; a flash drive, a tape drive; an optical drive; a RAID array; a random-access memory (RAM); and a read-only memory (ROM).

As described herein, a graphical component may be a graphical representation associated with pieces of code, such as pre-compiled code and/or other types of code, such as scripts (e.g., JavaScript, Python, HTML, etc.). The representations of the graphical program stored in the memories may include identifiers and parameters of the code as well as connections between code associated with each of the graphical components. The structures may also store execution sequence for the code. During execution of the one or more computer threads, the code may be executed in a sequence as stored in memory based on the representation, without compiling the code. For example, the system may use the representations to connect appropriate outputs and inputs and execute the code by passing properties.

According to some embodiments, as the user manipulates the graphical program (e.g., adds graphical components, selects configuration parameters, etc.), the code that implements the graphical program can be constructed step-by-step in response to the user’s graphical programming. According to some embodiments, when the user adds a new graphical component, the system adds code associated with the new graphical component to (any) existing code associated with existing graphical components. In some embodiments, the code can be pre-compiled code.

When a user modifies an existing graphical component in the graphical program or adds a selected graphical component to the existing graphical components, the system may update a non-visual representation of the graphical program (e.g., the configuration of code, such as pre-compiled code portions, associated with the user interface (UI) representation) in a first structure of a memory for creating the graphical programming interface (e.g., UI memory, local memory, front-end memory, etc.). According to some embodiments, a corresponding representation may be stored in a second structure of a memory for execution of code associated with the graphical components of the graphical program (e.g., back-end memory). The representation of the second memory may also be updated when a user modifies or adds to the graphical program (e.g., to keep both representations in sync with each other). For example, the data representation of the graphical programming diagram can be in UI memory and also on a back-end server, and can be constantly changed/updated as the user works on it and update it.

According to some embodiments, once the graphical program is complete, if the components are already pre-compiled and/or evaluated, the system need not compile and/or evaluate the associated code. Rather, the system can instead simply execute the code. In some embodiments, the system configures how the different executables are connected to each other for execution, such as by connecting the various executables/components in memory (e.g., by passing properties and/or parameters among the executable components).

According to some embodiments, the system can guide a user through adding new graphical components by displaying one or more locations within the existing graphical program that are each indicative of a valid location where the new graphical component can be properly added to the existing graphical program. In some embodiments, the system can display all possible locations where a new graphical component can be added. In some embodiments, the system can display a subset of the possible locations (e.g., based on the user indicating which portion or portions of the graphical program the user would like to add the new component to, such as by hovering over existing graphical components, existing thread(s), etc.). In some embodiments, when the new component is added to a valid location, the system can automatically include visual connections between the new component and existing component(s) in the graphical program (e.g., rather than requiring the user to add the connections).

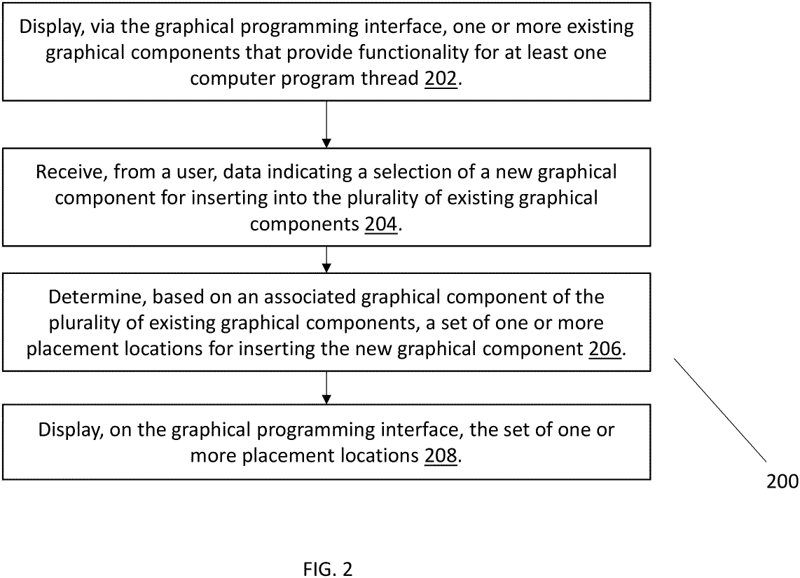

FIG. 2 is a flow chart showing an exemplary computerized method 200 for editing a graphical program using a graphical programming interface, according to some embodiments. At step 202, the system (e.g., the system 100 of FIG. 1) displays, via the graphical programming interface, one or more existing graphical components that configure (e.g., specify, provide, adjust, etc.) functionality for at least one computer program thread. For example, as described herein, each of the existing graphical components may be associated with code of the at least one computer program thread.

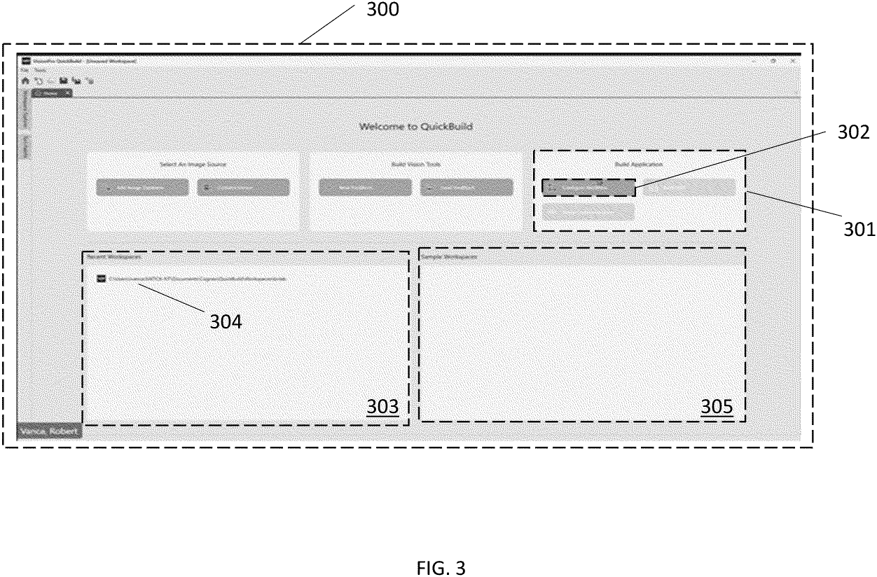

A graphical programming interface, such as graphical programming interface 140 may be displayed to the user in response to launching an application and opening a graphical program for editing in the application on a computer (e.g., computer 150), or as part of a web interface on a web browser. For example, a user may launch the application on computer 150 and open one or more graphical programs for editing. FIG. 3 is an exemplary display screen 300 of an application for an exemplary graphical programming interface upon launching the application, according to some embodiments.

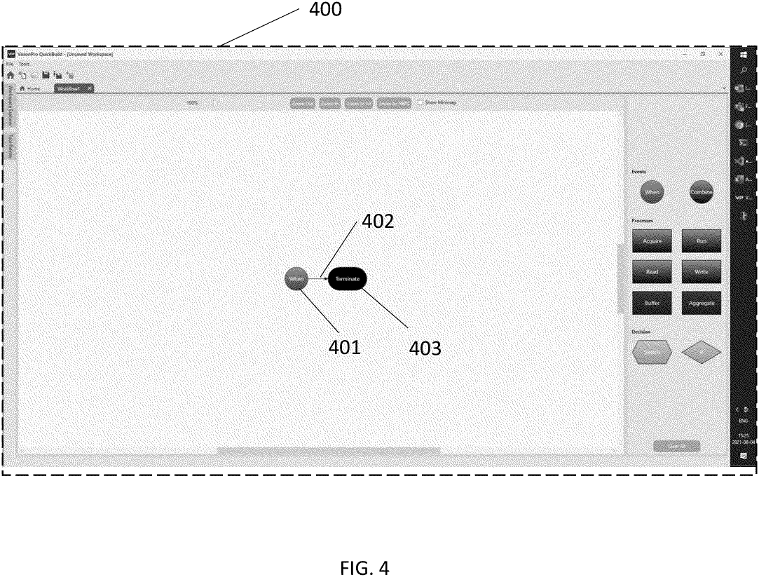

As described herein, the user may edit a graphical program using the graphical programming interface. In some embodiments, the system may display pre-existing and/or base components for creation of at least one computer program thread. For example, the user may open a pre-existing graphical program (e.g., from a previous session) such as by selecting an entry 304 listed in a first area 303. In another example, the user may open a sample graphical program (e.g., a graphical program provided by the application, a template graphical program, etc.) by selecting an entry listed in a second area 305. According to some embodiments, the user may create a new graphical program. For example, the user may select an option 302 listed in a third area 301 for creating new applications. FIG. 4 is a view of the exemplary graphical programming interface 400 following initialization, according to some embodiments. For example, the interface 400 may be displayed to the user (e.g., user 120) in response to the user selecting an option (e.g., option 302) to create a new application. For example, in some embodiments, the system may display a blank workspace or canvas prior to creation of the graphical program.

The graphical program may be initialized with one or more graphical components. In the example of FIG. 4, the graphical program is initialized with two graphical components including a first graphical component 401 and a second graphical component 403. In some examples, the first graphical component 401 is event-driven, such that when an event occurs, code associated with the graphical component may execute. For example, an event-driven graphical component may be called a ‘when’ component. In some examples, the second graphical component is a terminating component indicating termination of the program. According to some embodiments, a connection between the two graphical components may also be initialized, such as connection 402 between graphical components 401 and 403. A connection may indicate data flow, processing flow, or both, between the new graphical component and one or more graphical components connected to it. The connections may be displayed on the graphical programming interface as an arrow between two graphical components. According to some embodiments, connections between graphical components may be automatically populated.

In some embodiments, the relative location of a first graphical component to a second graphical component may represent an order in which code associated with each of the graphical components are executed.

As described herein, the connections between the graphical components may indicate data flow. In some embodiments, a connection may comprise an arrow. In some embodiments, the direction of the arrow can be indicative of data flow. For example, an arrow with a direction from left to right may indicate the direction of the data flow from a first graphical component on the left of the arrow (e.g., where the arrow begins) to a second graphical component to the right of the arrow (e.g., where the arrow points to or ends). For example, data may flow from the first graphical component to the second graphical component at which the arrow ends. In some examples, code corresponding to a graphical component from which an arrow begins may be executed prior to code corresponding to a graphical component at which the arrow ends.

As an illustrative example in FIG. 4, the first graphical component 401 and the second graphical component 403 may be connected by the connection 402, which may be an arrow pointing left to right from the component 401 to the component 403. The connection 402 may then represent that code associated with the first graphical component will be executed before code associated with the second graphical component is executed and that data flows from the first to second graphical component. In some embodiments, the graphical program may include other specified orders and/or flows, as discussed further herein.

According to some embodiments, a user may initialize the graphical component using one or more templates. For examples, options for templates may be listed for selection by the user, and in response to the selection by the user, one or more graphical components and connections between graphical components may be populated in the graphical programming interface.

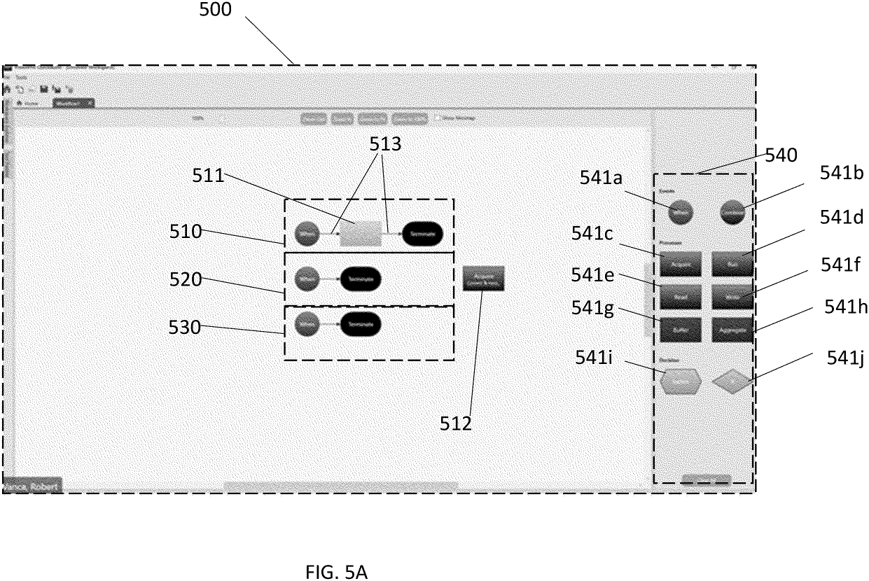

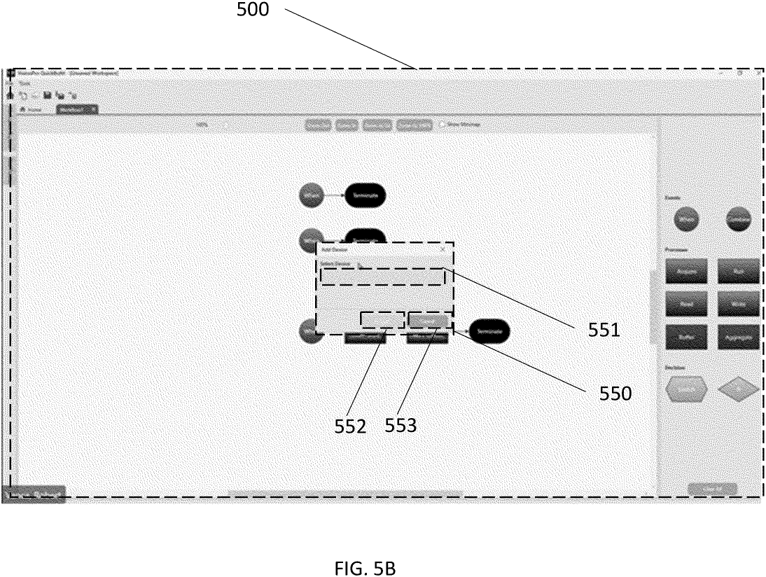

Referring further to FIG. 2, at step 204 the system receives, from a user, data indicating a selection of a new graphical component for inserting into the plurality of existing graphical components. For example, referring to FIG. 1 the user may select one of the graphical components 145 from the area 146 for adding to the graphical components 144 in the graphical programming interface. As described herein, a user may edit the graphical program using the graphical programming interface, for example, a user may select and insert a new graphical component into existing graphical components of the graphical program. For example, FIG. 5A is a view of the exemplary graphical programming interface when a user selects a graphical component for acquiring data, according to some embodiments. Graphical programming interface may display a graphical program having one or more threads. For example, the graphical programming interface 500 shows threads 510, 520, and 530, each including existing graphical components. For example, in FIG. 5A, each thread is initialized with an event-driven graphical component and a terminating component.

As described herein, the graphical programming interface may receive, from a user, data indicating a selection of a new graphical component for inserting into the existing graphical components. For example, the area 504 of the graphical programming interface may display a selection of options for new graphical component(s) for selection by the user, such as graphical components 541a-j. The user may use input devices to select one or more new graphical components from the options for graphical components (e.g., 541a-j) presented to the user. For example, the user may use input devices such as keyboards, and pointing devices, such as mice, touch pads, and digitizing tablets. As another example, a computing device may receive input information through speech recognition or in other audible format.

Referring further to FIG. 2, at step 206 the system determines, based on an associated graphical component of the plurality of existing graphical components, a set of one or more placement locations for inserting the new graphical component. In the example of FIG. 5A, the user has selected a new graphical component 512. The graphical component 512 may be associated with code for acquiring data, for example, using a connected device. The system (e.g., system 100) may determine, based on an associated graphical component of the existing graphical components, a set of one or more placement locations for inserting the new graphical component. For example, the associated graphical component may be the graphical component of the existing graphical components determined to be a last edited, last inserted and/or last selected graphical component. In some examples, the associated graphical component may be the graphical component of the existing graphical components having a position that is in closest proximity to the position of the selected new graphical component. For example, the system may determine placement locations based on code and/or rules associated with the associated graphical component and the new graphical component. In some embodiments, no compilation is performed to determine the placement locations.

At step 208 in FIG. 2, the system displays, on the graphical programming interface, the set of one or more placement locations. The system may display the set of the placement locations on the graphical programming interface. For example, the system may display the placement locations as an empty space (e.g., between two arrows, after one arrow, before one arrow), a box having no label, and/or the like. In the example of FIG. 5A, the placement location 511 is displayed on the graphical programming interface. In addition, one or more connections between the existing graphical components and the placement locations may be automatically determined and/or displayed on the interface as well, such as arrows 513 surrounding placement location 511. According to some embodiments, a real-time layout module (not shown) may determine a layout for displaying the one or more placement locations and the existing graphical components on the graphical programming interface. According to some embodiments, the system may determine a new set of placement locations and display the new set of placement locations when a position of the new graphical component (e.g., 512) changes.

As described herein, a graphical component may be associated with code that can be executed without compilation, such as pre-compiled code (e.g., one or more portions of code) and/or code that need not be compiled prior to execution (e.g., HTML, JavaScript, etc.). Each of these graphical components may have a representation in storage referencing and/or identifying the pieces of code. The graphical program may be stored as a structure in memory, comprising one or more representations associated with corresponding graphical component and identifying corresponding code. The structure may include identifiers and parameters of the code associated with each of the graphical components as well as connections between code associated with each of the connections between the graphical components. The structure and/or representations may also store execution sequence for the code. During execution of the one or more computer threads, the code may be executed in a sequence as stored in memory based on the structure and/or representations, without compiling the code. For example, the system may use the representations to connect appropriate outputs and inputs and execute the code by passing properties.

For example, adding the new graphical component 512 into the graphical programming environment includes updating the structure to include a representation corresponding to the new graphical component 512. A stored structure may include representations identifying and/or referencing code of the at least one computer program thread associated with existing graphical components of 510 and the system may update the stored structure by including representation corresponding to the new graphical component 512. The system (e.g., system 100) may also update a representation of the graphical program (e.g., the user interface (UI) representation of the pre-compiled pieces of code) in a first memory for creating the graphical programming interface as described herein.

According to some embodiments, when a user selects an existing graphical component (e.g., by clicking, tapping, double clicking the graphical component, and/or the like), the graphical interface may display a dialog box for configuring parameters of the graphical component and/or of code associated with the graphical component.

For example, FIG. 5B is an exemplary dialog box 550 for selecting a device for selecting an event that triggers the execution of code (e.g., code of a thread), according to some embodiments. The parameters may include what the event could be, options for selection between choices for multiple types of events that the user can choose from. For example, if the graphical program is for a vision system, and the connected device is a camera, the ‘when’ event-driven graphical component may be executed when there is a new image acquired. For example, clicking on the graphical component may provide options for 4 cameras to choose from. In some examples, the dialog box 550 may exist in the application and the software for configuring the camera may exist outside of the application.

In some examples, the graphical component may include a link, such as a clickable or selectable link that is displayed within the graphical component. In some embodiments, selecting the graphical component and/or selecting the link may direct the user to a new user interface, a separate software program and/or application, etc., without the users themselves needing to navigate to the new user interface, needing to launch another software program and/or application, etc. As a result, the user is provided with a link (e.g., clickable link) such that, when clicked, the user is automatically directed towards the appropriate software interface to improve the user’s experience. For example, when the techniques described herein are used for machine vision applications, a link can be used to automatically take the user to a user interface associated with a camera and/or imaging device.

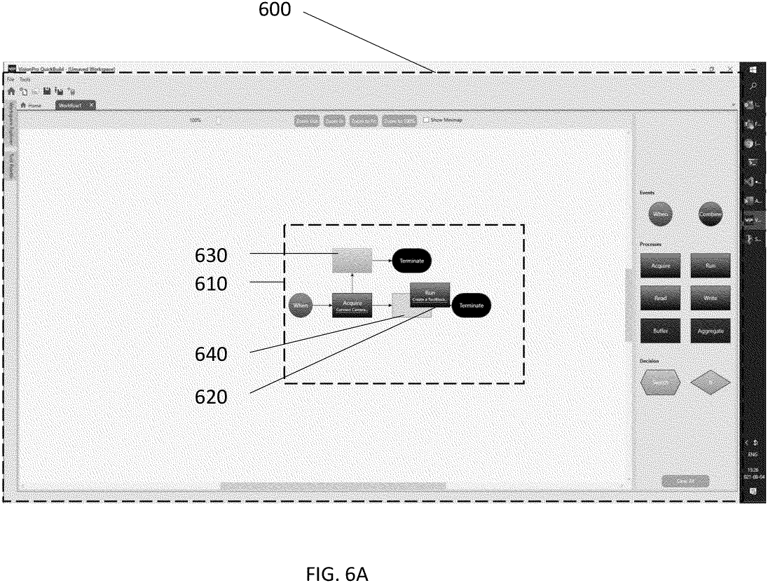

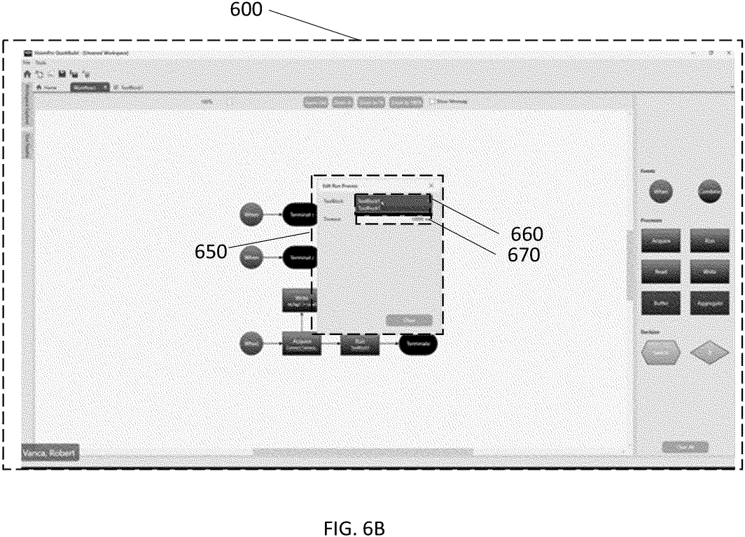

FIG. 6A is a view of the exemplary graphical programming interface 600 when a user selects a graphical component for running a process, according to some embodiments. As described herein a user may select a new graphical component for running a process (e.g., ‘run’). The system (e.g., system 100) may determine, based on an associated graphical component of the existing graphical components, a set of one or more placement locations for inserting the new graphical component. The system may determine placement locations 630 and 640 based on code and/or rules associated with the components of the graphical program 610 and the new graphical component. The placement locations 630 and 640 are then displayed to the user.

According to some embodiments, a user may select a graphical component of existing graphical components and in response to a selection of a graphical component, a dialog box may be displayed to the user via the graphical programming interface. In some examples, the dialog box is automatically populated with one or more options based on the existing graphical program. For example, the dialog box can be automatically populated with data that can be input to code associated with the selected graphical component based on data from code associated with graphical components that will be executed prior to the code associated with the at least one graphical component.

For example, FIG. 6B is an exemplary dialog box 650 for editing a run process, according to some embodiments. According to some embodiments, the user may select the graphical component 620 (e.g., double clicking on the graphical component) and the system may display dialog box 650 to configure parameters. For example, the user may select a tool block using the dropdown menu 660 and may configure a timeout time by inputting a value. According to some embodiments, the dialog box 650 is automatically populated with one or more options for data that can be input, for example, based on data from code associated with graphical components that will be executed prior to the code associated with the at least one graphical component. For example, the one or more options may be a dynamic set of options based on data that is available at the time of execution of the code associated with the graphical component.

As described herein, a graphical component of the graphical program may include a link to direct a user to another application. A graphical component for running a process (e.g., ‘run’ component 620) may also include a link as described herein. When the user selects the link of the graphical component, the system may graphically display and/or direct the user to another user interface. For example, the interface may be a tool block interface so that the user can create a tool block. According to some examples, the user can also configure the created tool block using the interface.

The user may return to the graphical programming interface 600 after using the one or more user interfaces and/or programs (e.g., launched by invocation of a link). In some examples, on returning to the graphical programming interface, the created tool block may be selected automatically as the tool block to be run (e.g., within the dialog box, updated in the structures in memory). For example, the selection for tool block 660 may be listed as created tool block ‘ToolBlock1’ .

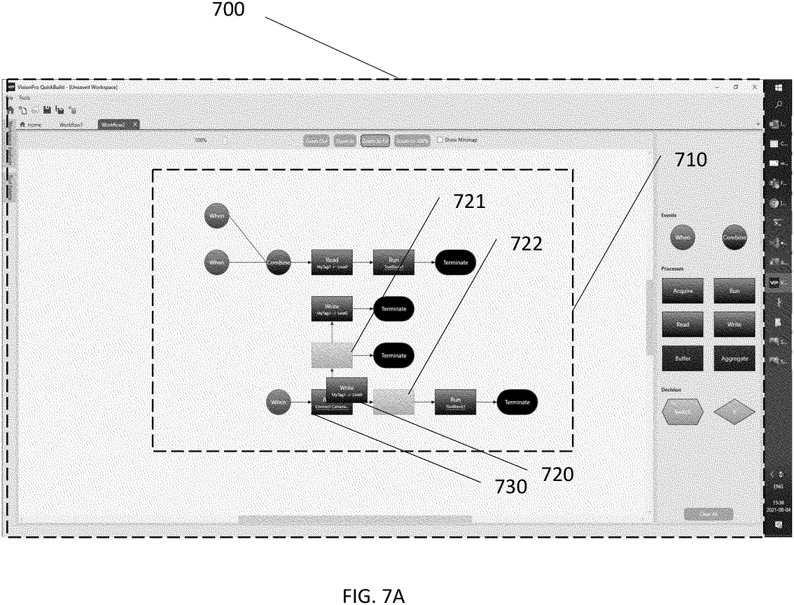

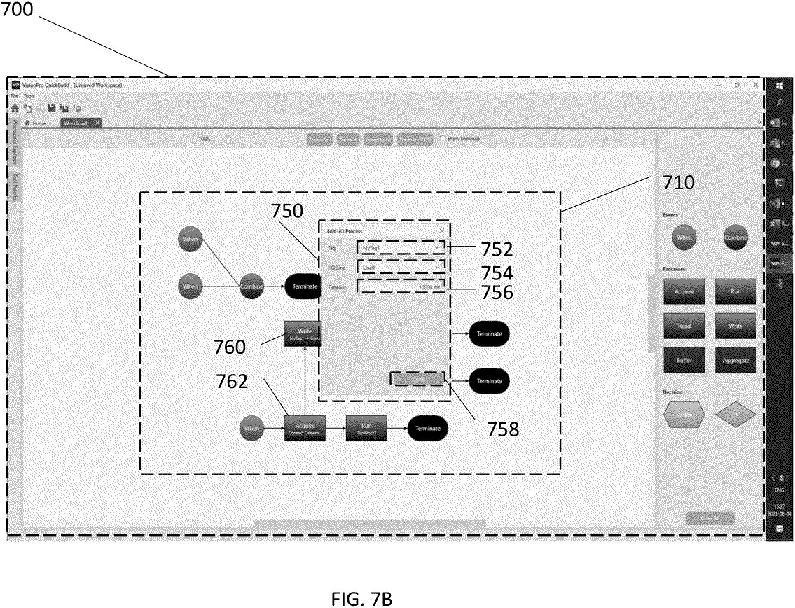

FIG. 7A is a view of the exemplary graphical programming interface 700 when a user selects a graphical component 720 for writing data, according to some embodiments. As described herein a user may select a new graphical component for writing data (e.g., ‘write’). The system (e.g., system 100) may determine, based on an associated graphical component of the existing graphical components, a set of one or more placement locations for inserting the new graphical component.

As described herein, the associated graphical component may be the graphical component of the existing graphical components determined to be a last edited, last inserted and/or last selected graphical component or the associated graphical component may be the graphical component of the existing graphical components having a position that is in closest proximity to the position of the selected new graphical component. In the example of FIG. 7A, the position of new graphical component 720 is closest in proximity to the position of graphical component 730 in the graphical programming interface. The system may determine placement locations 721 and 722 based on code and/or rules associated with the components 720 and 730. The placement locations are then displayed to the user as shown in FIG. 7A.

In some examples, the associated graphical component may be a graphical component over which the new graphical component is hovering or overlapping in the graphical programming interface 700. In the example of FIG. 7A, the new graphical component 720 is overlapping and/or hovering over the graphical component 730 in graphical programming interface 700. The system may determine placement locations 721 and 722 based on code and/or rules associated with the components 720 and 730. The placement locations are then displayed to the user as shown in FIG. 7A.

As described herein, according to some embodiments, a user may select a graphical component and in response a dialog box may be displayed to the user (e.g., which is automatically populated with one or more configuration options). For example, FIG. 7B shows an exemplary dialog box 750 of graphical programming interface 700 for editing an input/output (I/O) process of graphical program 710, according to some embodiments. In the example of FIG. 7B, the dialog box 750 may be displayed on the interface 700 in response to a user’s selection of graphical component 760. The dialog box 750 may display one or more options for the input/output (I/O) process. For example, the user may select a tag identifier for a tag using a dropdown menu 752. The user may also select an I/O line using dropdown menu 754. According to some embodiments, the user may input a timeout time (e.g., in milliseconds (ms)). Once the user has selected and configured the options using the dialog box 750, the user may exit the dialog box 750 and return to editing the graphical program 710 by selecting a ‘close’ option 758. In this example, the user has configured the graphical component 762 to write data from the tag with identifier ‘MyTag1’ to I/O line ‘0’ with a timeout of 10000 ms.

As described herein, the dialog box may be automatically populated with one or more options for data that can be input to code associated with the selected graphical component based on data from code associated with graphical components that will be executed prior to the code associated with the at least one graphical component. For example, the one or more options of the dropdown menus 752 and 754 may be presented based on code associated with graphical component 762, (e.g., ‘acquire’), which will execute prior to the execution of code associated with the graphical component 760. In other examples, the one or more options of the dropdown menu 754 may be a list of connected devices (e.g., connected to the system 100 or computer 150). The list may be a dynamic list containing identifiers of the devices connected at the time of displaying the list.

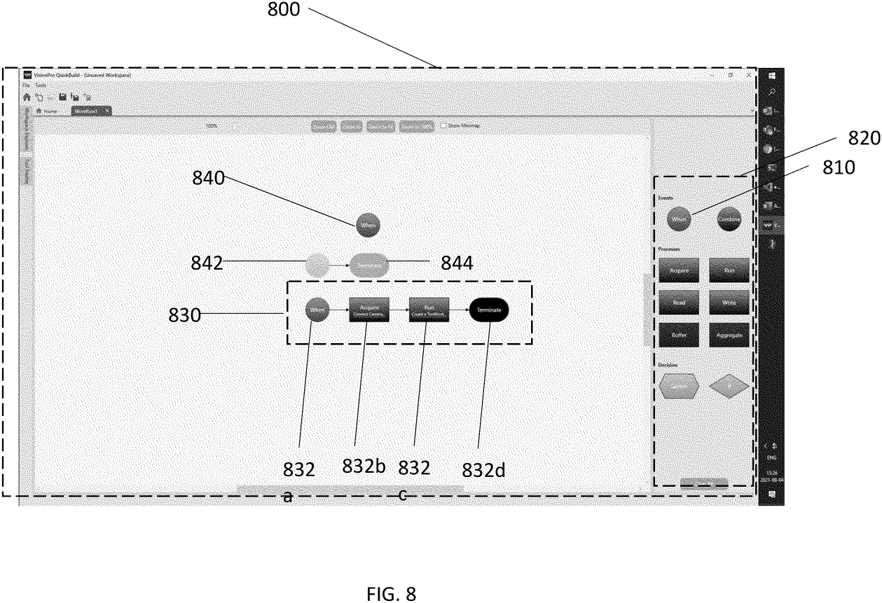

FIG. 8 is a view of the exemplary graphical programming interface 800 when a user selects a graphical component for an event-driven process, according to some embodiments. As described herein, the graphical programming interface may receive from a user, data indicating a selection of a new graphical component for inserting into the existing graphical components 832a-d of graphical program 830. An event-driven graphical component can include, for example, a “when” component that is triggered when data, an action, an event, etc. occur. Another example is a “combine” component that can combine event driven processes and/or data, as described further herein. For example, the user may select event-driven graphical component 810 from the selection of options in area 820 for new graphical components displayed on the graphical programming interface 800. In response to receiving data indicating a selection of a new event-driven graphical component, the graphical programming interface 800 may display one or more placement locations for placing the new graphical component. In the example of FIG. 8, placement location 842 is displayed to the user.

According to some embodiments, selecting an event-driven graphical component may automatically add a termination graphical component connected to the event-driven graphical component. Additionally, the placement locations may be placement locations for the event-driven graphical component in connection with the termination graphical component. For example, in the example of FIG. 8, a placement location 844 is displayed on the graphical programming interface for the termination graphical component.

The system (e.g., system 100) may receive data indicating placement of the event-driven graphical component, for example, in placement location 842. In response, the system may add the new graphical component 810 into graphical program 830 and may also automatically add a termination graphical component in placement location 844. Additionally, the system may add the connection between the event-driven graphical component 840 and the termination graphical component automatically. According to some examples, the system may add, automatically, one or more parameters associated with the event-driven graphical component and the termination graphical component to a structure in memory.

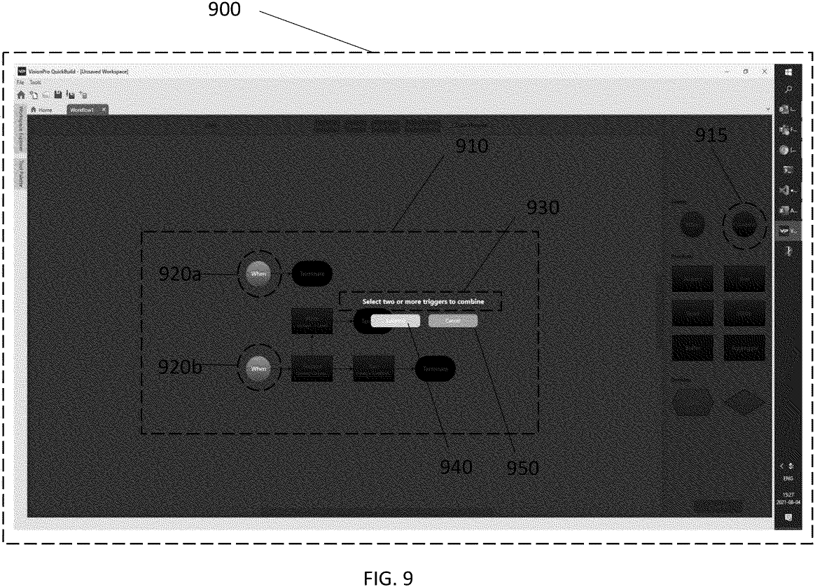

According to some embodiments, a graphical component may be used to combine two or more event-driven processes. For example, FIG. 9 is a view of the exemplary graphical programming interface 900 when a user selects a graphical component, such as graphical component 915, for combining two or more event-driven processes, according to some embodiments. The system can be configured to identify components in the graphical program that can be combined, and to gray-out other components to provide for easy selection by the user of which components to combine. The graphical programming interface displays graphical program 910 with graphical components of which graphical components 920a and 920b are labelled.

As described herein, the graphical programming interface may receive from a user, data indicating a selection of a new graphical component for inserting into the existing graphical components. For example, the user may select graphical component 915 for combining two or more event-driven processes (e.g., labelled in FIG. 9 as ‘Combine’) from the selection of options for new graphical components displayed on the graphical programming interface 900. In response to receiving data indicating a selection of a new graphical component for combining event-driven processes, the graphical programming interface 900 may prompt the user to select two or more event-driven processes to combine. For example, in FIG. 9, the prompt 930 prompts the user to “Select two or more triggers to combine.”

According to some embodiments, the graphical programming interface 900 may display event-driven processes that can be combined, such as event-driven graphical component 920a and 920b, for example, by highlighting and/or emphasizing the event-driven graphical components 920a and 920b on the graphical interface. The user may select the two or more event-driven graphical components and submit the combining graphical component for insertion by selecting a submit option 940. Alternatively, the user may select the cancel option 950 to resume editing the graphical interface without combining event-driven processes.

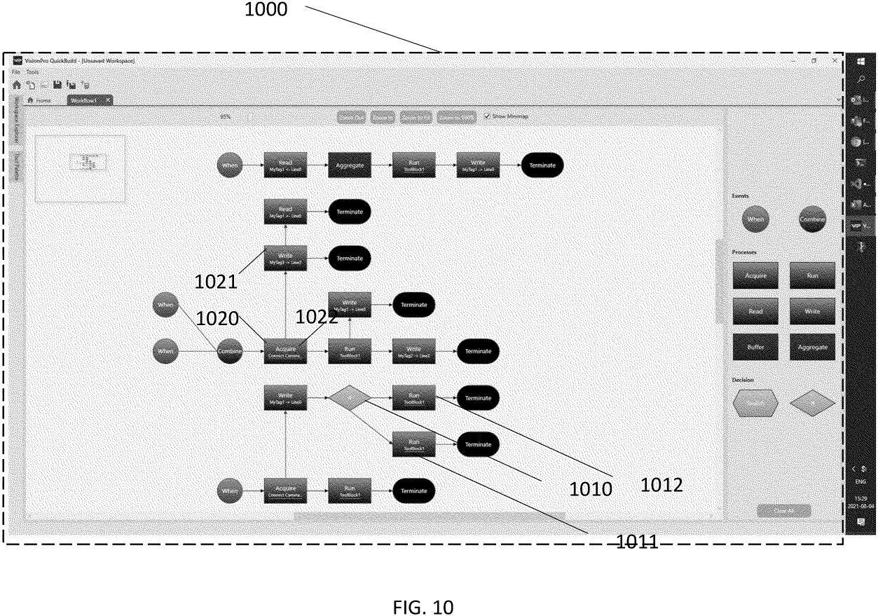

FIG. 10 is another view of the exemplary graphical programming interface 1000, according to some embodiments. As described herein, the relative location of a first graphical component to a second graphical component may represent an order in which code associated with each of the graphical components are executed.

As described herein, the connections between the graphical components may indicate data flow. In some embodiments, a connection may comprise an arrow. The direction of the arrow from left to right may indicate the direction of the data flow from a first graphical component on the left of the arrow (e.g., where the arrow begins) to a second graphical component to the right of the arrow (e.g., where the arrow points to or ends). Other execution paths and/or visual indications can be used as well (e.g., in addition to and/or alternatively to a left-to-right flow). For example, a connection may be an arrow pointing in an upward direction to a second graphical component from a first graphical component. This can indicate that code associated with the second graphical component is executed in response to an error occurring during execution of code associated with the first graphical component. For example, in FIG. 10, code associated with a graphical component 1021 with an arrow pointing upward from the graphical component 1020 to the graphical component 1021 may be executed in response to an error during execution of code associated with the graphical component 1020. If no error occurs during execution of code associated with the graphical component 1020, code of the graphical component 1022 to the right of graphical component 1020 may be executed.

As another example, a connection may be an arrow pointing downwards to a second graphical component from a first graphical component. This can represent that code associated with the second graphical component is a sub-step of code associated with the first graphical component. For example, branch or loop constructs can be indicated in the graphical programming environment using such a relationship. Such branches can be visually displayed as one or more sub-steps underneath to indicate that if the branch occurs, the program moves downwards, executes the one or more sub-steps, and then returns back up to proceed to the next program step.

According to some embodiments, a conditional graphical component may be associated with code such that based on a condition, code associated with one or more different graphical components connected to the conditional graphical component may be executed. For example, based on whether a condition is fulfilled or not based on code associated with ‘if’ graphical component 1010, code associated with graphical components 1011 and/or 1012 may be executed.

In some embodiments, the graphical program may result in a program that has multiple outputs or updates, compared to programs that simply execute once and provide a single output or update. For example, for a program built using the graphical programming environment, the program may have multiple UI updates that are displayed over time. As another example, the program may be a long-running process, which may have programmed pauses (e.g., a “when” block to wait a predetermined period of time, if triggered) prior to resuming execution. Accordingly, the program may provide real-time updates showing the execution path through the program visually to the user via the graphical program.

According to some embodiments, the graphical program may be launched. Once the program is launched, code associated with the graphical program may execute continuously until a user pauses execution. The graphical programming interface may show updates (e.g., live updates) as the code associated with each graphical component of the graphical program executes. For example, the graphical programming interface may display a path of execution through graphical components. In some examples, the user may be able to access values corresponding to inputs, outputs, variables of the code, and/or the like. According to some embodiments, the program may pause execution intermittently in order to update values corresponding to inputs, outputs, variables of the code, and/or the like.

According to some embodiments, code can be executed and paused (e.g., in order to facilitate debugging). For example, code of the at least one computer program thread associated with one or more graphical components of the plurality of existing graphical components may be executed in response to user input and code of the at least one computer program thread may also be paused automatically upon completing execution of code associated with the one or more graphical components or in response to user input. For example, a user may launch the program, and indicate to the system to pause execution of code associated with a graphical component at any point in time. In some examples, the user may pause execution after executing code associated with each graphical component. According to some embodiments, the program can be executed component-by-component across the graphical program components (e.g., where the user may provide an input to continue execution from a current component to a next component).

According to some embodiments, the graphical program may include script blocks. For example, the user may use the graphical programming interface to create scripts (e.g., using JavaScript, Python etc.). According to some embodiments, the scripts may be compiled and/or evaluated to ensure the script is valid, and when the script is added into the graphical program, the script may be executed and interpreted (e.g., using JavaScript or Python). In some embodiments, the script or portion(s) thereof can be executed without performing any compilation and/or evaluation (e.g., for pre-compiled and/or pre-evaluated portion(s) of code).

In some embodiments, the graphical programming interface may display a selection of options for new graphical component(s) for selection by the user, including a script graphical component. On selecting the new script graphical component and adding the new script graphical component to the existing graphical components, the graphical programming interface may display an editor (e.g., text editor, Integrated Development Environment (IDE), etc.) that allows the user to input code (e.g., by text and/or the like). In some examples, the system may allow programmatic access to an Application Programming Interface (API).

Techniques operating according to the principles described herein may be implemented in any suitable manner. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A computer-implemented method for editing a graphical program using a graphical programming interface, the method comprising:
displaying, via the graphical programming interface, a plurality of existing graphical components that provide functionality for at least one computer program thread;
receiving data indicating a selection of a new graphical component for inserting into the plurality of existing graphical components;
determining, based on an associated graphical component of the plurality of existing graphical components, a set of one or more placement locations for inserting the new graphical component; and
displaying, on the graphical programming interface, the set of one or more placement locations.

2. The method of claim 1, further comprising:
receiving data indicating a selected placement location from the set of one or more placement locations; and
adding the new graphical component into the plurality of existing graphical components based on the selected placement location.

3. The method of claim 1, further comprising:
receiving data indicating a second graphical component of the plurality of existing graphical components near where the selected graphical component to the plurality of existing graphical components may be added;
determining, based on the second graphical component, a second set of one or more placement locations for inserting the new graphical component into the plurality of existing graphical components near the second graphical component; and
displaying, on the graphical programming interface, the second set of one or more placement locations,
wherein the second graphical component is a graphical component of the plurality of existing graphical components determined to overlap the new graphical component in the graphical programming interface compared to other associated positions of the remaining existing graphical components of the plurality of existing graphical components.

4. The method of claim 1, wherein the associated graphical component is a graphical component of the plurality of existing graphical components determined to be a last edited graphical component.

5. The method of claim 1, wherein the new graphical component is associated with code and the code is configured with one or more parameters.

6. The method of claim 1, further comprising:
receiving data indicating a selection of an event-driven graphical component;
receiving data indicating placement of the event-driven graphical component;
adding the event-driven graphical component and automatically adding a termination graphical component connected to the new graphical component; and
adding, automatically, one or more parameters associated with the event-driven graphical component and the termination graphical component to a structure in memory.

7. The method of claim 2, wherein adding the new graphical component further comprises:
determining, automatically, one or more connections between the new graphical component and one or more graphical components of the plurality of existing graphical components; and
displaying one or more connections between the new graphical component and the one or more graphical components,
wherein the one or more connections indicate data flow, processing flow, or both, between the new graphical component and the one or more graphical components.

8. The method of claim 1, wherein determining the one or more placement locations comprises determining, based on rules associated with the new graphical component and/or the associated graphical component, one or more locations in the plurality of existing graphical components in which the new graphical component can be added, and
wherein displaying the one or more placement locations comprises determining a layout for displaying the one or more placement locations and the plurality of existing graphical components.

9. The method of claim 1, wherein at least one graphical component of the plurality of existing graphical components comprises a link.

10. The method of claim 1, further comprising:
redirecting to another interface in response to selection of the link.

11. The method of claim 1, further comprising:
displaying on the graphical programming interface, in response to a selection of at least one graphical component of the plurality of existing graphical components, a dialog box, wherein:
the dialog box is automatically populated with one or more options for data that can be input to code associated with the at least one graphical component based on data from code associated with graphical components that will be executed prior to the code associated with the at least one graphical component.

12. The method of claim 1, further comprising:
receiving data indicating selection of a combining graphical component for combining two or more graphical components;
displaying a prompt to select two or more graphical components of a plurality of existing graphical components; and
combining two or more graphical components based on a selection of two or more graphical components.

13. The method of claim 2, further comprising:
launching the at least one computer program thread in response to input; and
executing code associated with the new graphical component and/or code associated with one or more of the plurality of existing graphical components when a condition is met.

14. The method of claim 2, further comprising:
modifying a structure corresponding to the at least one computer program thread based on adding the new graphical component and/or the selected placement location of the new graphical component; and
executing the at least one computer thread by executing pre-compiled code associated with the new graphical component and pre-compiled code of the at least one computer program thread associated with the plurality of existing graphical components,
wherein the pre-compiled code associated with the new graphical component is configured with one or more parameters determined by the selected placement location of the new graphical component.

15. The method of claim 1, further comprising:
executing code of the at least one computer program thread associated with one or more graphical components of the plurality of existing graphical components in response to input; and
pausing execution of the at least one computer program thread automatically upon completing execution of code associated with the one or more graphical components.

16. The method of claim 1, further comprising:
indicating a graphical component on the graphical programming interface during execution of code associated with the graphical component of the plurality of existing graphical components.

17. The method of claim 1, further comprising:
executing code of the at least one computer program thread associated with one or more graphical components of the plurality of existing graphical components; and
displaying data on the graphical programming interface, wherein the data is an output of the executed code.

18. The method of claim 1, wherein a first graphical component of the plurality of existing graphical components is connected to a second graphical component of the plurality of existing graphical components,
wherein a position of the first graphical component directly connected to the left of the second graphical component represents that code associated with the first graphical component will be executed before code associated with the second graphical component is executed,
wherein a position of the second graphical component directly connected above the first graphical component represents that code associated with the second graphical component is executed in response to an error during execution of code associated with the first graphical component, and
wherein a position of the second graphical component directly connected below the first graphical component represents that code associated with the second graphical component is a sub-step of code associated with the first graphical component.

19. A non-transitory computer-readable media comprising instructions that, when executed by one or more processors on a computing device, are operable to cause the one or more processors to provide for editing a graphical program using a graphical programming interface, comprising:
displaying, via the graphical programming interface, a plurality of existing graphical components that provide functionality for at least one computer program thread;
receiving data indicating a selection of a new graphical component for inserting into the plurality of existing graphical components;
determining, based on an associated graphical component of the plurality of existing graphical components, a set of one or more placement locations for inserting the new graphical component; and
displaying, on the graphical programming interface, the set of one or more placement locations.

20. An apparatus for editing a graphical program using a graphical programming interface, the apparatus comprising a processor configured to execute programming instructions to perform:
displaying, via the graphical programming interface, a plurality of existing graphical components that provide functionality for at least one computer program thread;
receiving data indicating a selection of a new graphical component for inserting into the plurality of existing graphical components;
determining, based on an associated graphical component of the plurality of existing graphical components, a set of one or more placement locations for inserting the new graphical component; and
displaying, on the graphical programming interface, the set of one or more placement locations.
